(19) United States
(12) Patent Application Publication
(10) Pub. No.: US 2010/0026571 A1
(43) Pub. Date: Feb. 4, 2010

(54) Nautical Safety Beacon

(75) Inventor: Ernest William Batty, Eastleigh (ZA)

Correspondence Address: GROSSMAN, TUCKER, PERREAULT & PFLEGER, PLLC, 55 SOUTH COMMERICAL STREET, MANCHESTER, NH, 03101, US

(73) Assignee: INTERNATIONAL MARITIME INFORMATION SYSTEMS SA (PTY, Pretoria (ZA)

(21) Appl. No.: 12/306,388

(22) PCT Filed: Jul. 2, 2007
(86) PCT No.: PCT/IB2007/052567

§ 371 Date: Oct. 13, 2009

(30) Foreign Application Priority Data
Jul. 3, 2006 (ZA) 2006/05454

(51) Int. Cl. G01S 1/00; G01S 5/00; G01S 1/08

(52) U.S. Cl. 342/357.09; 342/357.1; 342/357.14; 342/386

(57) ABSTRACT

A signalling beacon which includes a global positioning system receiver, operable to determine a geographic location of the signalling beacon, a radio frequency transmitter operable to transmit a radio frequency signal, a radio frequency receiver operable to receive a radio frequency signal, a processor, operable to read the geographic location from the global positioning system receiver, to compile a data message containing the geographic location of the signalling beacon and to transmit the data message as a radio frequency signal via the radio frequency transmitter and a waterproof case for housing the global positioning system receiver, the radio frequency transmitter, the radio frequency receiver and the processor.

THIS INVENTION relates to nautical safety. In particular, the invention relates to a signalling beacon, to an electronic beacon, to a signalling beacon kit and to a distributed communication network.

### BACKGROUND OF THE INVENTION

The inventor is aware of nautical safety aids and aids to navigation. However, most sophisticated navigation aids and safety equipment are expensive and primarily used on large commercial maritime vessels in accordance with the Safety of life at sea (SOLAS) regulations. Furthermore, such systems are often mounted in vessels or are used as handheld units, which do not provide safety features for locating and tracking vessels in distress.

The inventor is also aware of safety beacons for tracking and locating vessels in distress, but such beacons do not have advanced communication capabilities.

The invention aims to address at least some of these aspects.

### SUMMARY OF THE INVENTION

According to the invention, there is provided a signalling beacon which includes

a global positioning system (GPS) receiver, operable to determine a geographic location of the signalling beacon;

a radio frequency (RF) transmitter operable to transmit a radio frequency signal;

a radio frequency receiver operable to receive a radio frequency signal;

a processor, operable to read the geographic location from the global positioning system receiver, to compile a data message containing the geographic location of the signalling beacon and to transmit the data message as a radio frequency signal via the radio frequency transmitter; and

a waterproof case for housing the global positioning system receiver, the radio frequency transmitter, the radio frequency receiver and the processor.

The RF receiver may be operable to receive a data message as part of the RF signal. The data message may comprise any one or more of a weather forecast/warning, a collision warning (CPA=Closest Point of Approach), a voice-call setup, a command to adjust reporting rate, an “approaching no-go area” warning, an “entering no-go area” warning, and a confirmation that assistance has been sent.

In addition, the RF receiver is operable to receive an analogue voice signal. This feature provides the RF receiver to transmit/receive data messages as well as analogue voice messages.

The radio frequency transmitter and radio frequency receiver pair may be operable as a radio frequency transceiver, to permit bi-directional communication between the signalling beacon and a remote radio frequency transceiver.

The processor may be operable to communicate via the RF transceiver by means of any one or both of the International Telecommunication Union's ITU-R M.493 protocol (in compliance with the recommendations of ITU-R M.541) and the ITU-R M.825 protocol.

Furthermore, the processor may be operable to set up voice calls in the DSC (Digital Selective Calling) format as defined in the International Telecommunication Union's ITU-R M.493 protocol and in ITU-R M.541.

The processor may be operable to receive all communications in the ITU-R M.493 format, such as weather warnings and the like.

The processor may be operable to transmit all types of data messages in the ITU-R M.825 format, such as geographic location data, and the like. In one embodiment, the processor may be operable to transmit geographic location data messages at predefined intervals.

The processor may be operable to transmit a distress signal via the RF interface in the ITU-R M.493 format. Similarly, the processor may be operable to transmit a distress signal at predefined intervals.

The processor may also be operable to receive a distress signal in the ITU-R M.493 format via the RF interface.

In particular, messages conforming to any one or both of the ITU-R M.493 format and the ITU-R M.825 format may be recognisable by transceivers conforming to the corresponding format(s).

In particular, to conform to existing standards, the transceiver may be operable to transmit and receive radio frequency signals in the Very High Frequency (VHF) and Ultra High Frequency (UHF) bands.

The accessory may be provided with an antenna that matches the frequency used. The antenna may extend from an antenna mount on one end of the case or the antenna may be enclosed within the case.

The signalling beacon may include a trigger mechanism connected to the processor operable, when triggered, to activate the GPS receiver to determine the geographic location of the beacon and to transmit the location via the radio frequency transmitter. This may be of particular use to identify and report distress situations via the signalling beacon.

The detection means may be in the form of a water switch or so called “sea switch”, in operation to detect if the device has been at least partially submerged in water. For example, if the signalling beacon comes in contact with water it may indicate and emergency situation and the water switch may therefore detect such a situation.

In a particular embodiment, the detection means may include any one of a continuity circuit, operable to detect an increased continuity between two or more electrodes, an optical water detection circuit, a floatation switch arrangement, or the like.

The signalling beacon may include a short range wireless communication interface operatively connected to the processor, operable to exchange digital data or analogue signals between the processor and a matched external communication interface. Importantly, the communication interface may be arranged not to compromise the sealing of the housing.

For example, the short range wireless communication interface may be in the form of an optical communication port, an inductive communication port, a short range radio frequency transceiver, or the like.

In one example, the wireless communication interface may include an infra-red (IR) optical transceiver, operatively connectable to a matched external transmitter/receiver pair of an external device located proximate the IR transceiver for exchanging data with the external device. In one embodiment, the IR transceiver may include an IR light emitting diode (LED) and a photo transistor, located inside the case, but in optical communication with the outside of the case.

The signalling beacon may include a visual indicator connected to the processor, such as a light emitting diode (LED), a Xenon tube, or the like.

The visual indicator may be operable as any one of a safety and navigational light flashing at an interval of say six minutes, an optical emergency beacon flashing at an interval of say thirty seconds, a status indicator flashing at a programmable interval and a working light which remains switched on for say five minutes.

The visual indicator may be activatable by the processor when the trigger mechanism is triggered.

In addition, the signalling beacon may include sound generating means connected to the processor. Similarly, the sound generating means may be activatable by the processor when the trigger mechanism is triggered.

The signalling beacon may include a connection zone on the body of the waterproof case, the connection zone having electrical terminals arranged therein and having attachment means, connectable to matched attachment means, the attachment means in use defining a liquid tight seal with the matched attachment means if a device with matched attachment means is connected to the signalling beacon.

Typically, the attachment means may be in the form of any one of a bayonet type connector, a screw type connector, or the like.

The electrical terminals may include any one or more of data terminals, power connection terminals, analogue communication terminals, and the like, operable to connect the signalling beacon to external devices.

In one embodiment, the connection zone may be circular and the electrical terminals may be radially spaced in the connection zone, in operation connectable to matched electrical terminals of a device having matched attachment means. By being spaced at different distances from a centre position, the terminals may be connected to similarly spaced terminals on external devices, so as to provide different connection methods to different types of devices.

Instead of the connection zone, the signalling beacon may include an inductive coupling mounted inside the case, connectable to a matched inductive coupling which may be located outside the case. In one embodiment, the inductive coupling may be in the form of a first coil located inside a casing wall in a position to be in magnetic communicating with a second coil locatable proximate the first coil, outside the casing.

The signalling beacon may include a fluxgate compass operatively connected to the processor, in use to determine a direction in which the signalling beacon is oriented. This may be of particular use in navigating a vessel in low visibility conditions.

In one embodiment, the waterproof case may have a dual-saucer shape, in use to define a stable floating platform. In this embodiment the centre of gravity of the beacon may be located below the seam of the dual-saucer, in operation to maintain the signalling beacon in an upright position.

Preferably, the operative upper saucer shaped surface may be of an electromagnetic reflective material to provide a surface that reflects radar frequency signals.

Furthermore, the operative upper saucer shaped surface may include an antenna mount. The antenna mount may be manufactured of any one or both of a di-electric isolation material and a translucent material. Preferably, the antenna mount may be positioned in the centre of the operative upper saucer shaped surface.

The visual indicator may be located inside the antenna mount. In operation, the antenna mount and the visual indicator will always be in an upright position to facilitate RF communication via the antenna and visual detection of the visual indicator over a large distance.

According to another aspect of the invention, there is provided an emergency beacon which includes

a waterproof case in the form of a dual-saucer shape; and

any one or more of an visual signalling beacon, a radar reflective surface and a radio frequency beacon, the emergency beacon having a weight distribution so that its centre of gravity is located below the dual-saucer shape seam line.

The waterproof case may be manufactured of a synthetic material, such as a plastic material, to withstand adverse environmental conditions.

The inventor found it advantageous to manufacture the waterproof case of the signalling beacon and the emergency beacon from metal. In particular, the inventor found that the case may define a ground plane for the antenna, the case may provide electromagnetic shielding to the electronic components housed inside the case, the case may increase the radar signature of a vessel, such as a vessel manufactured from an electromagnetic non-reflective material and the case may simplify the manufacturing and repair process.

According to another aspect of the invention, there is provided a signalling beacon kit, which includes

a signalling beacon as described; and

a user interface having a matched short range wireless communication interface in operation to communicate with the processor of the signalling beacon via the short range wireless communication interface.

The user interface may have a short range radio frequency interface operable to communicate with a matched short range RF interface of the signalling beacon.

The user interface may include any one or more of a user input device, a user display device and an audio communication interface.

The user input device may be in the form of any one of a keypad and a touch sensitive display screen, operable to receive information from a user by entering information on the input device, which information may for example include voice call setup information, activation of a distress signal, data text messages, programming information of the signalling beacon processor, operational data, a waypoint marker, or the like.

The operational data may for example refer to inputs related to fish being caught by a user. In particular, the operational data may include inputs associated with a particular type of fish caught, a particular size of fish caught, the number of fish caught and the mass of the fish caught.

The user display device may be in the form of any one of a light emitting diode display, a liquid crystal display and a plasma display, operable to display information to a user, which information is received from any one of the signalling beacon and the user interface and which includes any one or more of, operational information, weather reports, safety alerts, distress information from remote users, global positioning system location information, directional guidance information, a collision warning (CPA=Closest Point of Approach), a voice-call setup, a command to adjust reporting rate, an “approaching no-go area” warning, an “entering no-go area” warning and a confirmation that assistance has been sent.

The directional guidance information may provide an indicator to allow the signalling beacon to track a particular GPS position and the GPS position of another signalling beacon.

The audio communication interface may be in the form of a speaker/microphone combination, operable to receive and transmit audio signals via the signalling beacon from and to a matched remote audio transceiver.

The audio communication interface may include a voice call setup facility, operable upon receiving/transmitting a voice call setup message, to connect to a remote audio communication interface thereby to permit bidirectional communication between the audio communication interface and a remote audio communication interface.

In operation the signalling beacon kit may be used as a two way radio, permitting a user to communicate with another matched two way radio.

The signalling beacon kit may include a power supply, which is connectable to the power connection terminals of the signalling beacon, operable to provide electrical power to the signalling beacon.

The power supply may be in the form of a battery of electrochemical cells.

The signalling beacon kit may include an electrical charger, connectable to the power supply to recharge the power supply from an external power source.

The signalling beacon kit may include a programmer, which may be connectable to the data terminals of the signalling beacon, operable to generate programming commands for programming the signalling beacon processor.

The signalling beacon kit may include a holder for the signalling beacon into which the case of the signalling beacon may be removably mountable. The holder may include release means operable to release the signalling beacon from the holder. The release means may be in the form of any one of a manual release mechanism, an automatic release mechanism and an ejection mechanism.

The holder may include mounting means for mounting the holder to a vessel. In use, the holder may be mountable, such that, when the vessel capsizes, the signalling beacon will fall from the holder.

In addition, the holder may be fitted with ejection means for ejecting the signalling beacon if the holder is tilted beyond a predefined angle from the vertical. The ejection means may be in the form of a spring located inside the holder.

According to yet a further aspect of the invention, there is provided a distributed communication network, which includes

at least one signalling beacon as described; and

any one of a second signalling beacon and at least one coast station, operable to communicate with the at least one signalling beacon.

The invention will now be described, by way of example only, with reference to the following drawing.

### DRAWING(S)

In the drawings:

FIG. 1 shows a schematic block diagram of one embodiment of a signalling beacon, in accordance with the invention;

FIG. 2 shows a flow diagram of execution of a processor of the signalling beacon of FIG. 1;

FIG. 3 shows a schematic block diagram of one embodiment of a distributed communication network in accordance with the invention;

FIG. 4 shows a schematic diagram of another embodiment of a signalling beacon, in accordance with the invention;

FIG. 5 shows a user interface forming part of a signalling beacon kit, in accordance with the invention;

FIG. 6 shows a power supply forming part of a signalling beacon kit, in accordance with the invention; and

FIG. 7 shows a flow diagram of the execution of a processor of the signalling beacon of FIG. 4.

### EMBODIMENT OF THE INVENTION

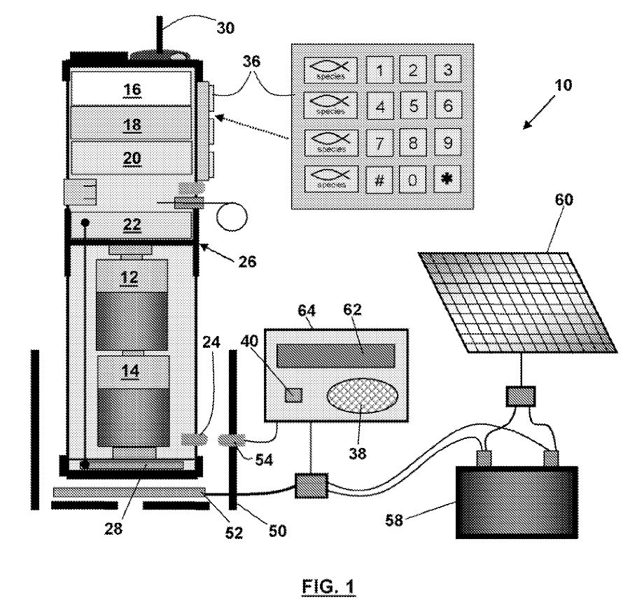

In FIG. 1, reference numeral 10 refers to a signalling beacon in accordance with the invention.

The beacon 10 includes a power supply in the form of two rechargeable batteries 12, 14 and power supply circuitry 22. The batteries 12, 14 and power supply circuit 22 are connected to a very high frequency (VHF) or ultra high frequency (UHF) transmitter/receiver pair (or transceiver) 16, to a global positioning system (GPS) receiver 18 and to a processor 20.

The beacon 10 includes a short range wireless communication interface in the form of an infra red (IR) optical transceiver 24 connected to the processor 20 for transmitting and receiving data to and from a matched communication interface.

The batteries 12, 14, the transceiver 16, the GPS receiver 18, the processor 20 the power supply circuitry 22 and the IR transceiver 24 are all located in a waterproof case 26 which is constructed of plastic.

The beacon 10 further includes an inductive coupling in the form of an inductive coil 28 located at the bottom of the case 26 and connected to the power supply circuitry 22.

At a top end of the case 26 an antenna 30, which is connected to the VHF transceiver is provided and extends upwardly in a normal operating condition of the beacon 10. The antenna is matched to the RF frequency being used,

A trigger mechanism in the form of a draw pin 32 includes switching means (not shown), which is connected to the processor 20, in operation to trigger a particular mode of operation of the processor 20.

A visual indicator 34 is provided on top of the case 26, to be visible, when the beacon 10 is in its normal upright operating orientation. The visual indicator is in the form of a light emitting diode (LED) and is connected to the processor 20, to be activated and deactivated by the processor in certain modes of operation.

A data input terminal 36 is connected to the processor 20 and operable to receive inputs from a user. In this embodiment, the data input terminal 36 is for entering data related to fish that has been caught. The processor 20 is operable in one mode of operation to transmit the data captured by the user to a remote receiver.

The beacon 10 includes an indicator in the form of three light emitting diodes (LED's) (not shown) which are connected to the processor 20 to provide a user with information on the weather, the charging state of the batteries 12, 14 and the operational mode of the processor 20.

The beacon 10 is shown mounted in a holder 50, which includes an inductive coil 52 and an IR transceiver 54.

When the beacon 10 is located in position in the holder 50, the IR transceiver 24 of the beacon 10 is in optical communication with the matched IR transceiver 54. Furthermore, the inductive coil 28 of the beacon 10 is in magnetic coupling with the matched inductive coil 52 of the holder 50.

The inductive coil 52 is connected to an external power source 56, which is connected to a battery of electrochemical cells 58 and/or a solar panel 60.

In operation the battery 58 powers the external power source 56, which generates an alternating current in the coil 52 of the holder 50 to induce electricity in the inductive coil 28 of the beacon 10, thereby to charge the batteries 12, 14 via the power supply circuit 22 of the beacon 10.

An audio communication interface in the form of a speaker 38 and a microphone 40 is combined with a data display in the form of a liquid crystal display 62 in a data unit 64.

The speaker 38, the microphone 40 and the display 62 is connectable to the processor 20 and the transceiver 16 via the IR transceivers 24, 54.

In operation, a user can communicate to a remote audio transceiver (not shown) via the speaker 38, microphone 40 and transceiver 16 operating as a two way radio.

Furthermore, in operation, certain data may be displayed to a user on the LCD display.

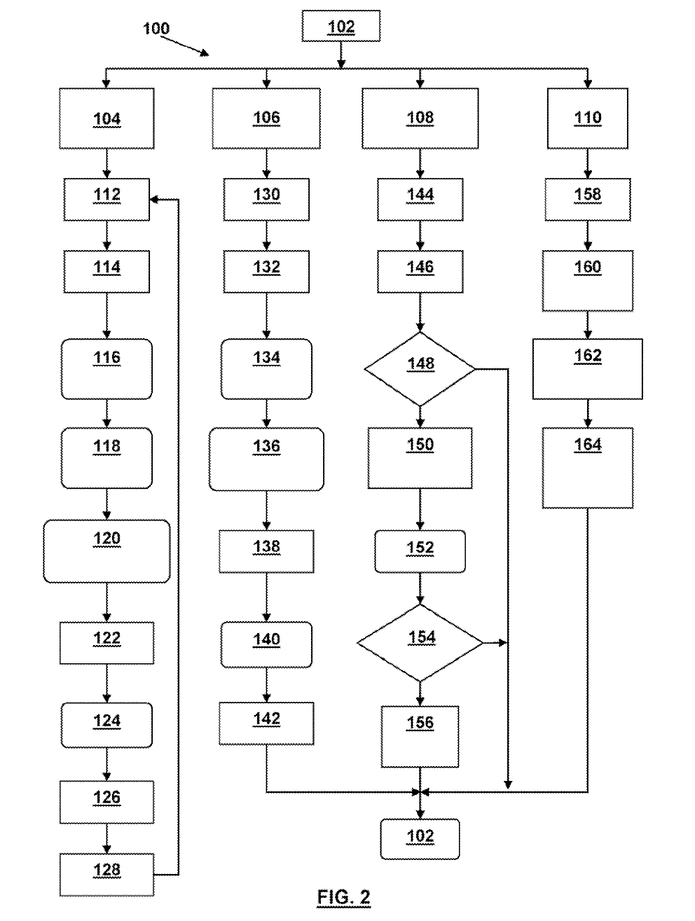

In FIG. 2 the operation of the processor 20 is shown in a flow diagram 100.

At 102, the processor is in a low power state (sleep mode) in which little power is consumed by the electronic components of the beacon 10.

At 104, 106, 108 and 110, certain events activate the processor 20 to exit the low power state.

At 104 the draw pin 32 is retracted from the case 26 and the switching means is activated. The withdrawal of the draw pin 32 is indicative of an emergency situation.

At 112, the processor 20 is activated to an operational state. The GPS 18 is activated at 114 and the visual indicator 34 and an audible beacon (not shown) is activated.

At 118 an updated position is received from the GPS 18 and at 120 a distress packet is constructed in the ITU-R M.493 format.

The RF transceiver 16 is activated at 122 and the distress signal is transmitted at 124, the transmitter is de-activated at 126 and the processor returns to the low power state at 128 for a period of 30 seconds. When the processor is re-activated operation resumes at 112. The beacon includes switching means (not shown) operable to disconnect the electronic components from the power supply 22. The switching means op operable to switch when the beacon 10 is turned upside down. Thus, the distress cycle is reset when the beacon is turned upside down.

At 106 a real time clock of the processor 20 generates an event. At 130 the processor 20 is activated from its low power state. The GPS is activated at 132, a location is obtained from the GPS at 134 and at 136 a location report message in the ITU-R M.825 format is constructed. At 138 the transmitter is activated, the location report message is transmitted at 140 and the transmitter is de-activated at 142, where after the processor 20 returns to its low power state at 102.

If a weather alert is received by the RF transceiver 16, an event is generated at 108 and the processor is activated from its low power state at 144. The RF receiver is activated at 146 and the received signal is checked for a particular carrier signal at 148. If no carrier signal is detected at 148 the processor returns to its low power state at 102. If a carrier signal is detected at 148, the processor 20 waits to receive a message at 150. The processor waits to detect a predefined synchronisation pattern which is associated with a weather alert. The message is received at 152 and identified as a weather message at 154. If the message is not a weather message, the processor 20 returns to its low power state at 102. If the received message is a weather message the indicator is activated to display the weather status to a user. Optionally an audio signal may be generated via the speaker 38, to attract the attention of the user. The processor 20 returns to a low power state at 102.

If a key is pressed on the data input terminal 36, at 110, the processor is activated at 158. The user provides inputs on the data input terminal 36 at 160. In this example the data may include data related to the fishing activities of the user, i.e. the number of fish caught etc. The data is stored in a memory of the processor at 164 and the processor 20 returns to its low power state at 102. If the next location report is compiled at 132, the data entered by the user is included in the location report message and transmitted at 140.

It is to be appreciated that the operation of the processor 12 and the other electronic components are optimised in order to preserve electrical power.

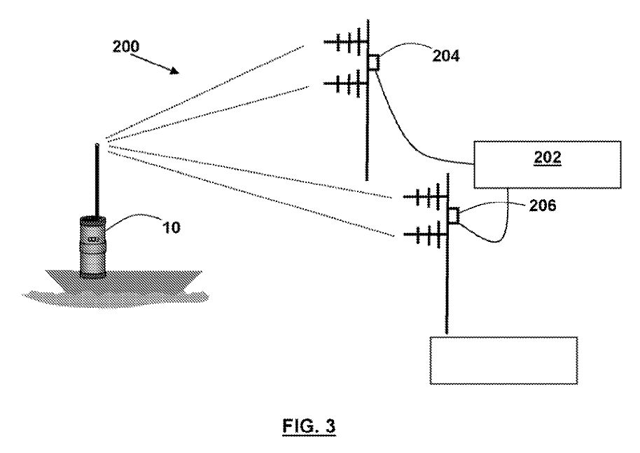

In FIG. 3, a locating system 200 in accordance with the invention is illustrated.

The locating system includes at least one beacon 10 in accordance with the invention and a base station 202, operable to communicate with the beacon 10 and to decode its message in the ITU format.

Two antennas and reception processors 204, 206 are connected to the base station 202.

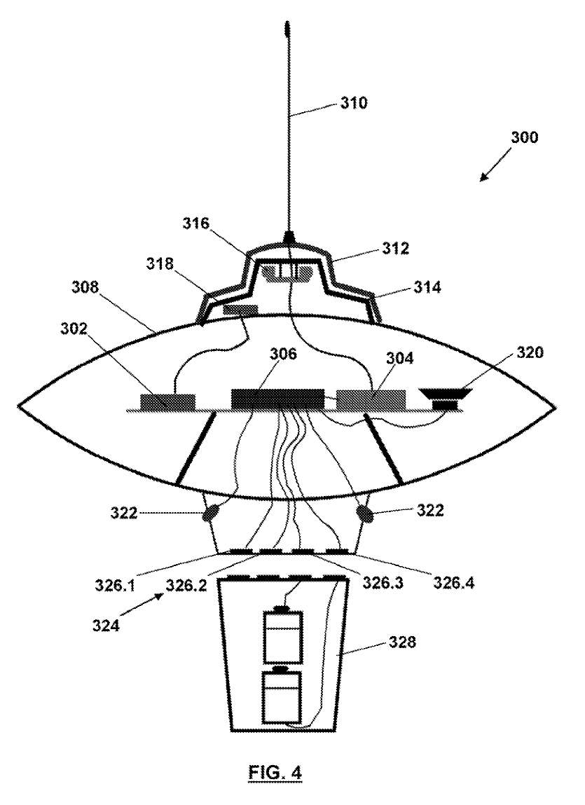

In FIG. 4 another embodiment of a signalling beacon 300 is shown. The beacon 300 includes a GPS receiver 302, an RF transmitter/receiver pair or transceiver 304, a processor 306, all of which are operatively connected and housed in a waterproof case 308.

The beacon 10 further includes an antenna 310 mounted on an antenna mount 312 on an operative upper side of the dual saucer shaped case 308.

A ground plane 314 is connected to the water proof case 308. A visual indicator in the form of a set of LED's 316 is located underneath the antenna mount 312, which is of a translucent material.

A GPS antenna 318, connected to the GPS receiver 302 is also located underneath the antenna mount.

An audible beacon 320, connected to the processor is located inside the case 308.

A trigger mechanism 322 in the form of a pair of electrodes of a so called “sea switch” is provided on an operative lower side of the case 308.

A connection zone 324 is provided on the operative lower side of the case 308, with four electrical terminals 326. It is to be appreciated that more electrical terminals can be provided in the connection zone 324.

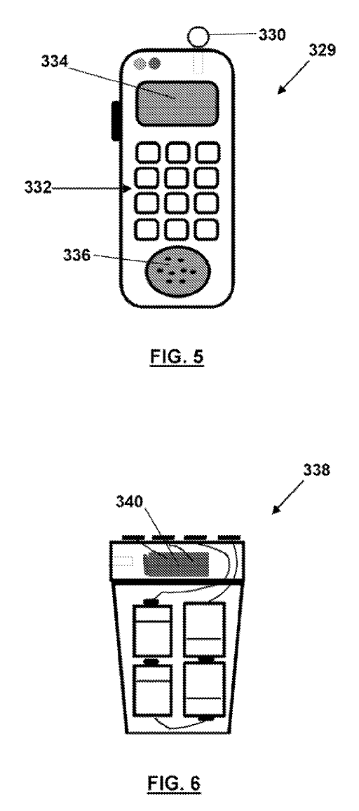

Two terminals 326.3, 326.4 are provided for connecting the beacon 10 to a power supply 328. The terminals 326.1, 326.2, or other terminals (not shown) are provided for connecting the processor 306 to a matched short range RF interface 340, shown in FIG. 6.

In FIG. 5 a user interface 329 is shown. The user interface 329 includes a short range RF interface (not shown) connected to an antenna 330.

A user input device in the form of a keyboard 332 is shown with a user display device in the form of a liquid crystal display (LCD) 334.

The user interface 329 further includes an audio communication interface in the form of a speaker/microphone combination 336.

In operation the handheld user interface 329 communicates with external communication devices via its short range RF interface 340 and the signalling beacon 300.

In FIG. 6 another power supply 338 is shown, which shows a matched short range RF interface 340 which provides the signalling beacon 300 with the short range communication capabilities via the data terminals 326.1, 326.2 and possibly other data terminals (not shown).

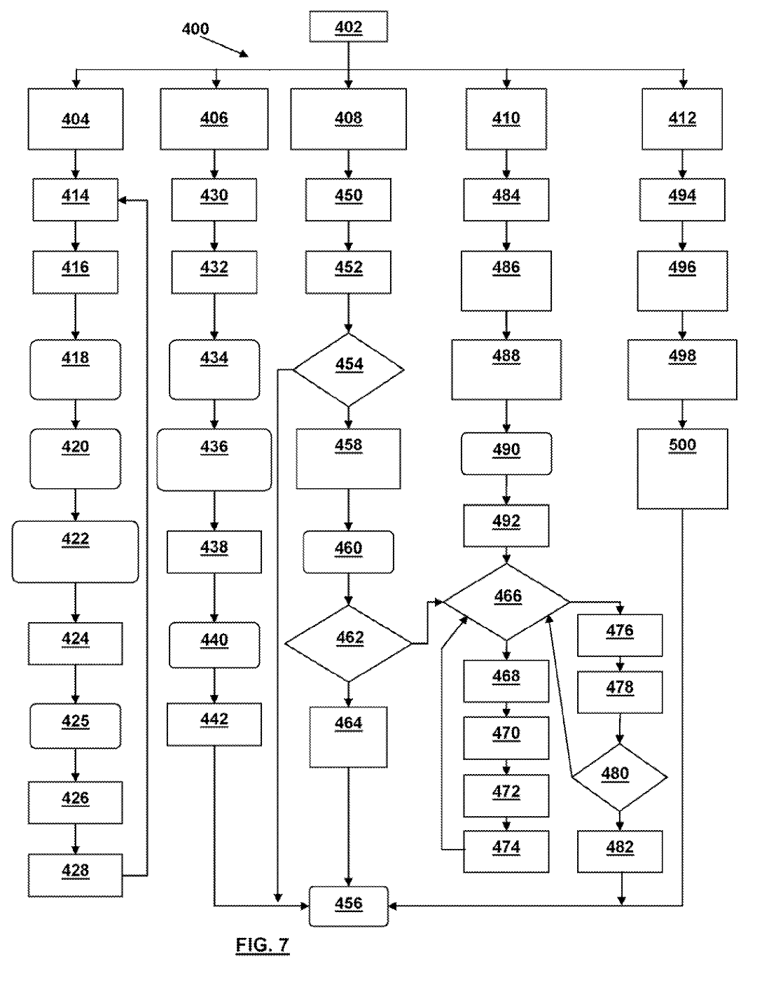

In FIG. 7, execution of the processor 306 is shown in a flow diagram 400.

At 402, the processor 306 is in a low power state (sleep mode) in which little power is consumed by the electronic components of the beacon 300.

At 404, 406, 408, 410 and 412, certain events activate the processor 306 to exit the low power state.

At 404 the “sea switch” is activated to indicate an emergency situation.

At 414, the processor 306 is activated to an operational state. The GPS 302 is activated at 416 and the visual indicator 316 and the audible beacon 320 are activated at 418.

At 420 an updated position is received from the GPS 302 and at 422 a distress packet is constructed in the ITU-R M.493 format.

The RF transceiver 304 is activated at 424 and the distress signal is transmitted at 425, the transceiver 304 is de-activated at 426 and the processor 306 returns to the low power state at 428 for a period of 30 seconds. When the processor is re-activated operation resumes at 404.

At 406 a real time clock of the processor 306 generates an event. At 430 the processor 306 is activated from its low power state. The GPS 302 is activated at 432, a location is obtained from the GPS at 434 and at 436 a location report message in the ITU-R M.825 format is constructed. At 438 the transceiver 304 is activated, the location report message is transmitted at 440 and the transceiver 304 is de-activated at 442, where after the processor 20 returns to its low power state at 102.

If a data message is received by the RF transceiver 304, an event is generated at 408 and the processor 306 is activated from its low power state at 450. The RF transceiver 304 is activated at 452 and the received data is checked for a particular preamble 454. If no preamble is recognised at 454 the processor 306 returns to its low power state at 456. If a carrier signal is detected at 454, the processor 306 waits to receive a message at 458.

At 460 the transceiver 304 is disabled. At 462, the received data message is checked to determine if a voice-call setup preamble was received and if not, the visual indicator 316 and audible beacon 320 is activated at 464 in accordance with the received data message.

If a voice-call setup preamble was received at 462 a press to talk (PTT) button (not shown) status is checked at 466.

If the PTT button was pressed, an audio signal is relayed from the handheld user interface 329 to the signalling beacon transceiver 304 at 468. The transceiver 304 is activated at 470 and at 472 operation is halted until the PTT button is released.

Once the PTT is released, the transceiver 304 is disabled at 474.

If the PTT button was not pressed at 466, an audio signal is to be received from the signalling beacon transceiver 304 at 476. The transceiver 304 is therefore activated at 478 and the audio status is monitored at 480. If the received audio signal is active the execution returns to 466, but if the audio signal is inactive at 480, the transceiver 304 is disabled at 482 and the processor 306 returns to a low power state at 456.

If the processor 306 is in a low power state at 402 and the PTT button is pressed, the processor 306 is activated at 484.

The processor 306 compiles a voice-call setup data message at 486 and the transceiver 304 is activated at 488. The data message is transmitted at 490 and the transceiver 304 is de-activated at 490.

The status of the PTT is monitored at 466 and execution therefrom proceeds as described above.

If the processor 306 is in a low power state at 402 and a keypad button is pressed at 412, the processor 306 is activated at 494. The user is prompted for inputs via the LCD screen 334 at 496. At 498, inputs are read from the keypad 332 and stored for transmission of the next data message at 500.

The inventor believes that the invention as described and illustrated provides a new signalling beacon, a new electronic beacon, a new signalling beacon kit and a new distributed communication network. In particular, the inventor believes that the combination of features as set out above provides a cost advantage, an operational advantage and a safety advantage to potential users of the beacon and the network, previously not available in either sophisticated existing navigational aids or existing radio beacons.

What is claimed is:

1. A signalling beacon which includes
a global positioning system receiver, operable to determine a geographic location of the signalling beacon;
a radio frequency transmitter operable to transmit a radio frequency signal;
a radio frequency receiver operable to receive a radio frequency signal, the radio frequency transmitter and radio frequency receiver pair operable as a radio frequency transceiver, to permit bi-directional communication between the signalling beacon and a remote radio frequency transceiver;
a processor, operable to read the geographic location from the global positioning system receiver, to compile a data message containing the geographic location of the signalling beacon, to transmit the data message as a radio frequency signal via the radio frequency transmitter, and to receive a data message as a radio frequency signal via the radio frequency receiver; and
a waterproof case for housing the global positioning system receiver, the radio frequency transmitter, the radio frequency receiver and the processor.

2. A signalling beacon as claimed in claim 1, in which the radio frequency receiver is operable to receive a data message as part of the radio frequency signal.

3. A signalling beacon as claimed in claim 2, in which the data message comprise any one or more of a weather forecast/warning, a collision warning, a voice-call setup, a command to adjust reporting rate, an “approaching no-go area” warning, an “entering no-go area” warning, and a confirmation that assistance has been sent.

4. A signalling beacon as claimed in claim 1, in which the radio frequency receiver is operable to receive an analogue voice signal.

5. A signalling beacon as claimed in claim 4, in which the processor is operable to communicate via the RF transceiver by means of any one or both of the International Telecommunication Union's ITU-R M.493 protocol and the ITU-R M.825 protocol.

6. A signalling beacon as claimed in claim 5, in which the processor is operable to set up voice calls, receive voice call messages and to participate in voice calls.

7. A signalling beacon as claimed in claim 5, in which the processor is operable to receive weather warnings using the ITU-R M.493 format.

8. A signalling beacon as claimed in claim 5, in which the processor is operable to transmit the geographic location data message via the RF transceiver.

9. A signalling beacon as claimed in claim 8, in which the processor is operable to transmit the geographic location data message at predefined intervals.

10. A signalling beacon as claimed in claim 5, in which the processor is operable to transmit a distress signal via the RF interface.

11. A signalling beacon as claimed in claim 10, in which the distress signal is transmitted in the ITU-R M.493 format.

12. A signalling beacon as claimed in claim 10, in which the processor is operable to transmit a distress signal at predefined intervals.

13. A signalling beacon as claimed in claim 5, in which the processor is operable to receive a distress signal via the RF interface.

14. A signalling beacon as claimed in claim 5, in which the RF transceiver is operable to transmit and receive radio frequency signals in the Very High Frequency (VHF) and Ultra High Frequency (UHF) bands.

15. A signalling beacon as claimed in claim 1, which includes a trigger mechanism connected to the processor, the trigger mechanism having detection means is in the form of a water switch, in operation to detect if the device has been at least partially submerged in water, the trigger mechanism operable, when triggered, to activate the GPS receiver to determine the geographic location of the beacon and to transmit the location via the radio frequency transmitter.

16. A signalling beacon as claimed in claim 15, in which the detection means includes any one of a continuity circuit, an optical water detection circuit and a floatation switch arrangement

17. A signalling beacon as claimed in claim 1, further comprising a short range wireless communication interface operatively connected to the processor, operable to exchange any one of digital data and analogue signals between the processor and a matched external communication interface.

18. A signalling beacon as claimed in claim 17, in which the short range wireless communication interface is in the form of any one of an optical communication port, an inductive communication port and a short range radio frequency transceiver.

19. A signalling beacon as claimed in claim 15, further comprising a visual indicator connected to the processor.

20. A signalling beacon as claimed in claim 19 in which the visual indicator is in the form of any one of a light emitting diode (LED) and a Xenon tube.

21. A signalling beacon as claimed in claim 19 in which the visual indicator is activatable by the processor when the trigger mechanism is triggered.

22. A signalling beacon as claimed in claim 15, further comprising sound generating means connected to the processor.

23. A signalling beacon as claimed in claim 22, in which the sound generating means is activatable by the processor when the trigger mechanism is triggered.

24. A signalling beacon as claimed in claim 1, which includes a connection zone on the body of the waterproof case, the connection zone having electrical terminals arranged therein and having attachment means, connectable to matched attachment means, the attachment means in use defining a liquid tight seal with the matched attachment means if a device with matched attachment means is connected to the signalling beacon.

25. A signalling beacon as claimed in claim 24, in which the attachment means is in the form of any one of a bayonet type connector and a screw type connector.

26. A signalling beacon as claimed in claim 24, in which the electrical terminals includes any one or more of data terminals, power connection terminals and analogue communication terminals.

27. A signalling beacon as claimed in claim 24, in which the connection zone is circular and in which the electrical terminals are radially spaced in the connection zone, in operation connectable to matched electrical terminals of a device having matched attachment means.

28. A signalling beacon as claimed in claim 1 which includes a fluxgate compass operatively connected to the processor, in use to determine a direction in which the signalling beacon is oriented.

29. A signalling beacon as claimed in claim 1 in which the waterproof case is dual-saucer shaped to define a stable floating platform.

30. A signalling beacon as claimed in claim 29, in which the waterproof case, when connected to a power source defines a floating platform of which the centre of gravity is located below a seam of the dual-saucer, in operation to maintain the signalling beacon in an upright position.

31. A signalling beacon as claimed in claim 30, in which an operative upper saucer shaped surface is of an electromagnetic reflective material to define a surface that reflects radar frequency signals.

32. A signalling beacon as claimed in claim 31, in which the upper saucer shaped surface includes an antenna mount.

33. A signalling beacon as claimed in claim 32, in which the antenna mount is manufactured of any one or both of a di-electric isolation material and a translucent material.

34. A signalling beacon as claimed in claim 33, in which the visual indicator is located inside the antenna mount.

35. A signalling beacon as claimed in claim 1, in which the waterproof case of a metal.

36. An emergency beacon which includes
a waterproof case in the form of a dual-saucer shape; and
any one or more of an visual signalling beacon, a radar reflective surface and a radio frequency beacon, the emergency beacon having a weight distribution so that its centre of gravity is located below the dual-saucer shape seam line.

37. An emergency beacon as claimed in claim 36, in which the waterproof case of metal.

38. A signalling beacon as claimed in claim 17, further comprising a user interface having a matched short range wireless communication interface in operation to communicate with the processor of the signalling beacon via the short range wireless communication interface.

39. A signalling beacon kit as claimed in claim 38, in which the user interface has a short range radio frequency interface operable to communicate with a matched short range RF interface of the signalling beacon.

40. A signalling beacon kit as claimed in claim 39, in which the user interface includes any one or more of a user input device, a user display device and an audio communication interface.

41. A signalling beacon kit as claimed in claim 40, in which the user input device is in the form of any one of a keypad and a touch sensitive display screen, operable to receive information from a user by entering information on the input device, which information includes any one or more of voice call setup information, activation of a distress signal, data text messages, programming information of the signalling beacon processor, a waypoint marker and operational data.

42. A signalling beacon kit as claimed in claim 39, in which the user display device is in the form of any one of a light emitting diode display, a liquid crystal display and a plasma display, operable to display information to a user, which information is received from any one of the signalling beacon and the user interface and which includes any one or more of, operational information, weather reports, safety alerts, distress information from remote users, global positioning system location information and directional guidance information.

43. A signalling beacon kit as claimed in claim 40, in which the audio communication interface is in the form of a speaker/microphone combination, operable to receive and transmit audio signals via the signalling beacon from and to a matched remote audio transceiver.

44. A signalling beacon kit as claimed in claim 43, in which the audio communication interface includes a voice call setup facility, operable upon receiving/transmitting a voice call setup message, to connect to a remote audio communication interface thereby to permit bidirectional communication between the audio communication interface and a remote audio communication interface.

45. A signalling beacon kit as claimed in claim 38, which includes a power supply, which is connectable to the power connection terminals of the signalling beacon, operable to provide electrical power to the signalling beacon.

46. A signalling beacon kit as claimed in claim 45, in which the power supply is in the form of a battery of electrochemical cells.

47. A signalling beacon kit as claimed in claim 45, which includes an electrical charger, connectable to the power supply to recharge the power supply from an external power source.

48. A signalling beacon kit as claimed in claim 38, which includes a holder for removably holding the signalling beacon when in use.

49. A signalling beacon kit as claimed in claim 48, in which the holder includes release means operable to release the signalling beacon.

50. A signalling beacon kit as claimed in claim 39, which includes a programmer, which is connectable to the data terminals of the signalling beacon, operable to generate programming commands for programming the signalling beacon processor.

51-56. (canceled)
